(19) United States
(12) Patent Application Publication
(10) Pub. No.: US 2007/0062970 A1
(43) Pub. Date: Mar. 22, 2007

(54) Dispensing apparatus for disposable gloves or like

(76) Inventors: Arjang Agahi, Dunadry, County Antrim (GB); Orang Agahi, Belfast (GB)

Correspondence Address: VAN DYKE, GARDNER, LINN AND BURKHART, LLP, 2851 CHARLEVOIX DRIVE, S.E., P.O. BOX 888695, GRAND RAPIDS, MI, 49588-8695, US

(21) Appl. No.: 10/596,206

(22) PCT Filed: Jun. 6, 2004
(86) PCT No.: PCT/EP04/13915

§ 371 Date: Jun. 2, 2006

(30) Foreign Application Priority Data
Dec. 4, 2003 (GB) 0328133.4

(51) Int. Cl. G01F 11/00

(52) U.S. Cl. 222/1

(57) ABSTRACT

An apparatus (20, 120, 220, 320) for dispensing an item, especially a glove (1, 101, 201, 301), having a body portion and an opening allowing access to the interior of the body portion. The apparatus comprises a chamber (6, 106 206, 306) having a mouth being shaped and dimensioned to receive the opening of the item so as, to provide a substantially fluid-tight seal at the mouth and such that at least part of the, or each, body portion is located inside the chamber. The apparatus further comprises means (7, 107) for causing a pressure differential between the interior surface and exterior surface of said at least one item. The pressure differential causes the item(s) to expand outwardly and this facilitates the insertion of a hand, or other object, therein.

### FIELD OF THE INVENTION

The present invention relates to a dispensing, or fitting, apparatus, particularly, but not exclusively, for use with disposable gloves.

### BACKGROUND TO THE INVENTION

Gloves, especially thin-walled or disposable gloves, and similar items, are now in common use in various industries, such as health-care, dentistry, vetenary surgeons, and other miscellaneous industries including catering. Such gloves, or other items, are commonly manufactured from natural rubber latex and other latex alternatives such as Vinyl or Nitrile. The gloves are typically used to provide a barrier for protecting the hands of the wearer, as well as, in clinical cases, protecting a patient from cross-contamination.

Putting on a thin-walled glove can be a difficult operation, especially if the would-be wearer's hand is moist from perspiration or from being washed prior to wearing, or in cases where double gloves are worn (glove on glove). This difficulty arises because the glove is usually formed from a deformable material that is resilient and elastic and which fits tightly onto the hand.

Moreover, conventional methods of donning gloves, even in clinical situations, are not compatible with keeping the gloves sterile or with preventing cross-contamination.

The present invention aims to mitigate the problems outlined above.

The invention is described hereinafter in the context of gloves, especially thin-walled gloves, but is not limited thereto and may equally be used with other items, especially items to be worn on a user's hand, finger(s), arm(s) or other body parts. For example, the invention may be used with finger cots (a finger cot typically comprises a resilient, elastic sheath for fitting over a user's finger).

### SUMMARY OF THE INVENTION

Blowing air into a glove, or other item, causes it to expand. This occurs as a result of unequal pressures on the internal and external surfaces of the item. If the (outward) pressure on the interior surface of the item is increased, then the volume of the item is increased until the internal and external pressures are equalised.

When a glove has expanded from its original size, it may easily be applied to a hand. However, it is not particularly practical to apply a glove under conditions in which the interior of the glove is pressurised. Apparatus embodying the invention reduce pressure at the exterior of a glove, or other item, thereby causing the item to expand.

Accordingly, a first aspect of the invention provides an apparatus for dispensing an item having a body portion and an opening allowing access to the interior of the body portion, the apparatus comprising a chamber having a mouth, the mouth being shaped and dimensioned to receive the opening of the item, the opening of at least one item being fitted to the mouth, in use, so as to provide a substantially fluid-tight seal at the mouth and such that at least part of the, or each, body portion is located inside the chamber; the apparatus further comprising means for causing a pressure differential between the interior surface and exterior surface of said at least one item.

Preferably, said chamber comprises an opening, said pressure differential causing means comprises means for evacuating air, or other gas, from said chamber through said chamber opening. The evacuating means may comprise a gas extraction means such as a pump or fan. The evacuating means may comprise means for expelling gas from the chamber.

In some embodiments, the chamber opening is fitted with a valve, the valve being operable in at least a first mode in which it permits gas to be expelled from the chamber through the chamber opening and substantially prevents gas from being drawn into the chamber through the chamber opening. Advantageously, the valve is operable in a second mode in which gas is permitted to enter the chamber through said chamber opening.

In some embodiments, the chamber is reversibly compressible, the volume defined by the chamber depending on the state of compression of said at least a portion of the chamber. The at least a portion of the chamber may comprise at least one fluted portion that is foldable in a concertina-like manner. The chamber may comprise a body having a plurality of substantially parallel flutes, the body being foldable in a concertina-like manner.

In some embodiments, the apparatus includes a removable lid for the mouth of the chamber, the lid, when fitted over the mouth, forming a substantially fluid tight seal around the mouth and said at least one item to create a first and a second sealed section in the apparatus, said first and second sections being partitioned by said at least one item, and wherein each of said first and second sections are maintained, before the lid is removed, in a state of partial vacuum.

A collar may be provided around the chamber mouth, the collar being arranged to receive the opening of said at least one item. The collar may project from the mouth in a direction generally perpendicular with the plane in which the mouth lies.

A second aspect of the invention provides a dispensing system comprising the apparatus of the first aspect of the invention, the system further including said at least one item fitted to the chamber mouth. Said at least one item may comprise at least one glove, preferably formed at least partially from resilient elastic material.

A third aspect of the invention provides a method of dispensing an item having a body portion and an opening allowing access to the interior of the body portion, the method comprising fitting the opening of at least one item to the mouth of a chamber so as to provide a substantially fluid-tight seal at the mouth and such that at least part of the, or each, body portion is located inside the chamber; and causing a pressure differential between the interior surface and exterior surface of said at least one item.

In preferred embodiments, the apparatus is adapted for dispensing a glove (or other item which has an opening, or mouth) formed from deformable material, the apparatus comprising: a chamber with a mouth; and means for creating a partial vacuum in the chamber, wherein the mouth of the chamber is arranged to receive the opening of the glove or other item. The glove, or other item, is fitted to the mouth of the chamber such that the glove is mostly located within the chamber and that the glove opening faces outwardly of the chamber.

With the opening of the glove, or other item, fitted to the mouth of the chamber, the glove, or other item, effectively seals the chamber at the mouth and allows a partial vacuum to be created in the chamber. The partial vacuum causes the glove, or other item, to inflate thereby allowing a user to fit his hand, or other body part, into the glove, or other item.

In some embodiments, the mouth of the chamber serves to hold the opening of the glove, or other item, in an open or stretched state. In alternative embodiments, a ring may be fitted to the glove, or other item, opening to hold it in an open, or stretched state. In such embodiments, the mouth of the chamber is adapted to receive the ring. Preferably, a latch, or other dislodging means, is provided adjacent the mouth of the chamber and arranged to dislodge the ring from the glove, or other item, as a user withdraws his gloved hand, or other body part, from the chamber. The dislodging means may be provided whether or not the ring is used.

A preferred method of dispensing a glove, or other item, formed from deformable material, involves: fitting the glove, or other item, to a chamber such that the glove, or other item's, opening faces outwardly of the chamber and that the glove, or other item, is located mainly within the chamber; and causing a partial vacuum to be created within the chamber.

The invention is especially but not exclusively, suitable for use with items formed from resilient, elastic material.

Further, the invention is particularly, but not exclusively, suitable for use with items that are required to be kept sterile before use.

Further advantageous aspects of the invention will become apparent to those ordinarily skilled in the art upon review of the following description of specific embodiments and with reference to the accompanying drawings.

### BRIEF DESCRIPTION OF THE DRAWINGS

Embodiments of the invention are now described by way of example and with reference to the accompanying drawings in which like numerals are used to denote like parts and in which:

FIG. 1 shows a glove suitable for use with dispensing apparatus embodying the invention;

FIG. 2 shows a side view of a ring that, in one embodiment, may be used with the glove or other item to be dispensed;

FIG. 3 shows a close-up view of part of one embodiment of a dispensing apparatus, and of a glove fitted with the ring of FIG. 2;

FIG. 4 shows a simplistic embodiment of a dispensing apparatus, and a glove, in a first state of use;

FIG. 5 shows the apparatus of FIG. 4 in a second state of use;

FIG. 6 shows a second embodiment of a dispensing apparatus, and a glove, in a first state of use;

FIG. 7 shows the apparatus of FIG. 6 in a second state of use;

FIG. 8 shows a third embodiment of a dispensing apparatus, and a glove, in a first state of use;

FIG. 9 shows the apparatus of FIG. 8 in a second state of use;

FIG. 10 shows a second embodiment of a dispensing apparatus, and a glove, in a first state of use; and

FIG. 11 shows the apparatus of FIG. 10 in a second state of use;

### DETAILED DESCRIPTION OF THE DRAWINGS

Referring now to the drawings, FIG. 1 shows an item to be dispensed or fitted, the item taking the form of a glove 1. The glove 1 may-be made of rubber (natural or synthetic), plastics or fabric, sterile or non-sterile, or of other suitable deformable material (especially resilient, elastic material). The glove 1 includes an opening or mouth 9 through which, in use, a user's hand (not shown) is inserted in order to don the glove 1. The glove 1 may include a peripheral ring 2 (not necessarily a circular ring) around the mouth 9. The peripheral ring 2 is typically integrally formed with the glove 1 and may, for example, take the form of a rolled portion of the glove 1. Typically, the peripheral ring 2 is formed from resilient, elastic material (usually the same material from which the glove is made).

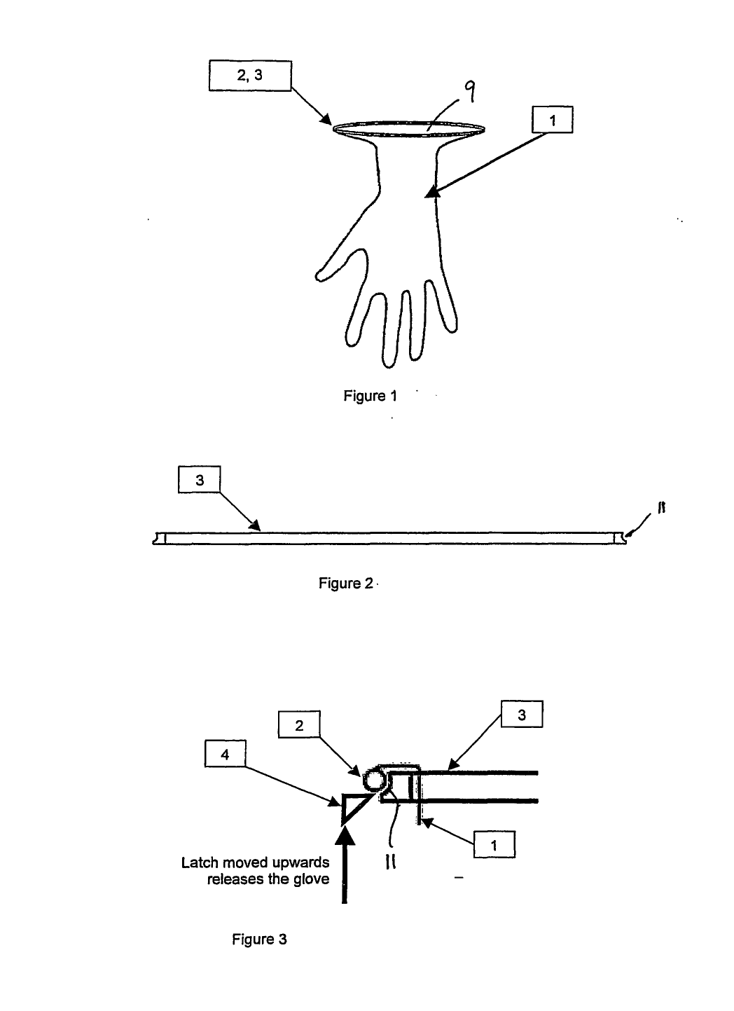

In some embodiments, a rigid (or semi-rigid) support ring 3 (not necessarily a circular ring) may be provided for holding the mouth 9 of the glove 1 in an open or deployed state (as shown in FIG. 1). As may best be seen from FIG. 2, the outer surface of the ring 3 may be shaped to define a seat 11 for receiving the peripheral ring 2 of the glove 1. FIG. 3 shows a portion of the support ring 3 with the peripheral ring 2 seated thereon.

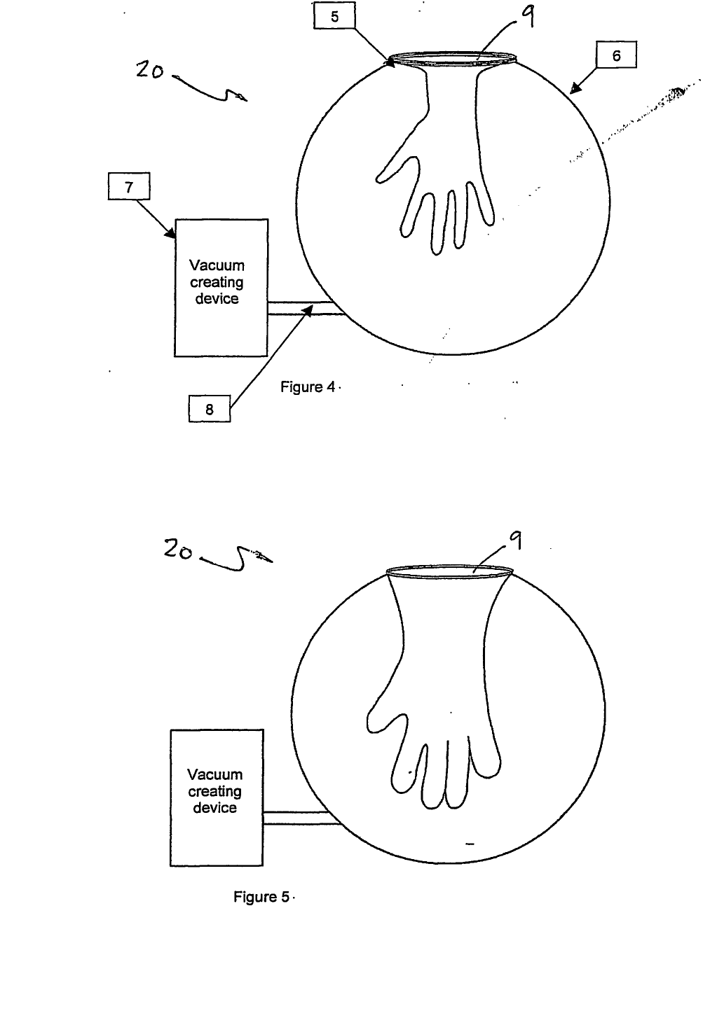

FIG. 4 shows a simple embodiment of a dispensing apparatus 20. The apparatus 20, and subsequent embodiments described hereinafter, are described in the context of gloves although the invention is not limited to gloves. The apparatus 20 may be considered as a dispensing apparatus in that it facilitates the fitting of gloves or other items. The apparatus 20, and other embodiments, may alternatively be described as an apparatus for fitting or deploying an item.

The apparatus 20 comprises a chamber 6 and means for evacuating at least some of the air (or other gas) from the chamber 6. In FIG. 4, the evacuating means takes the form of a vacuum creating device 7, such as a vacuum pump or a fan. The vacuum device 7 is connected to the chamber 6, typically by means of a connecting tube 8, so that the vacuum device 7 can create a partial vacuum in the chamber 6 (when sealed) by extracting air therefrom.

The glove 1 may be supplied mounted on the ring 3, the ring providing a structure that enables the glove to be supported at its opening 9. The ring 3 may take any convenient shape, e.g. generally circular or oval. The ring 3 may be expandable and, in its expanded state, need not necessarily be rigid. Gloves may be supplied in a cartridge (not shown) for ease of loading into the dispenser 20. The glove 1 may equally be supplied without the ring 3, the mouth 9 of the glove 1 itself being fitted to the dispenser 20. A plurality of gloves 1 may be fitted to the dispenser 20 simultaneously, each glove being fitted inside or over an adjacent glove. In such cases, the innermost glove may be dispensed first, although this need not necessarily be the case.

The chamber 6 is advantageously formed from rigid material and may be made of transparent material for improved visibility and visual feedback for the user. The chamber 6 has an opening 5, or mouth, for receiving, or seating, the ring 3 (on which the glove 1 is mounted), or the glove 1 itself (without the ring 3). To this end, the chamber mouth 5 has a peripheral lip or collar on which the glove 1 or ring 3 may be seated. To facilitate retention of the glove 1 or ring 3, the lip or flange may be provided with one or more grooves or ridges running around its outer periphery. When the glove 1 (with or without the ring 3) is fitted on the dispenser 20, its mouth 9 is located over the mouth 5 of the chamber 6, faces outwardly of the chamber 6 and is hence exposed to the external environment. Most of the glove 1 is located within the chamber 6, as can be seen from FIG. 4. The glove 1 is fitted to the chamber 6 such that it forms an air tight or substantially air-tight seal with the chamber mouth 5.

During use, one or more gloves are located in the chamber 6 with the mouth 9 fitted to the mouth 5 of the chamber 6. In this state (FIG. 4), the dispenser 20 may be said to be armed or loaded. The vacuum creating device 7 is activated in any suitable manner, for example manually, automatically or semi-automatically e.g. by the use of a proximity detector, an infra red detector, or a mechanical hand or foot switch. This causes air (or any other gas contained within the chamber 6) to be evacuated from the inside of the chamber 6. Since the chamber mouth 5 is sealed by the glove 1, the evacuation of air causes a pressure differential between the air pressure inside the chamber 6 and the ambient air pressure. In particular, the air pressure inside the chamber 6 is lower than the ambient air pressure. The ambient air pressure acts on the internal surfaces of the glove 1 since the mouth 9 of the glove 1 is exposed to the external environment As a result, the glove ‘inflates’ or expands as depicted in FIG. 5. In this expanded state, the glove 1 may readily receive a user's hand (not shown).

The vacuum creating device is then de-activated in any suitable manner, for example manually, automatically or semi-automatically e.g. by the use of a proximity detector or an infra-red detector located inside or outside the chamber, or by the release of the mechanical hand or foot switch.

In cases where the ring 3 is present, the glove 1 may be released from the ring 3 by a mechanical action. In the illustrated embodiment, the chamber 6 is provided with a latch 4 (FIG. 3) located externally of the chamber 6 adjacent the mouth 5. The latch 4 is movable with respect to the mouth 5 in a direction generally perpendicular with the plane of the mouth 5. The latch 4 is positioned for engagement with the portion (in this case the peripheral ring or rolled end 2) of the glove 1 that is fitted to the mouth 5 during movement of the latch 4. As viewed in FIG. 4, the rolled end 2 of the glove 1 is pushed in an upward direction by the latch 4 such that the rolled end 2 is released from the ring 3 (when present) or dislodged from the mouth 5. The hand may now be withdrawn from the chamber with the glove 1 fitted. When the ring 3 is present, it may be left around the mouth 1 and disposed of appropriately. In an alternative embodiment, the ring 3 may remain coupled to the glove 1 after the glove 1 has been fitted to the user. In one embodiment the ring comprises one or more rigid, or semi-rigid portions and one or more elastic, resilient portions, thereby causing the ring to adopt a contracted state (in which the ring is preferably substantially rigid) in the absence of external forces while being expandable to fit over the mouth of the chamber. In other cases, where the ring 3 is not used and at least the peripheral ring 2 is made from resilient, elastic material, the arrangement is such that the peripheral ring 2 is held in a stretched state when fitted to the mouth 5 and contracts to a rest state when dislodged from the mouth 5.

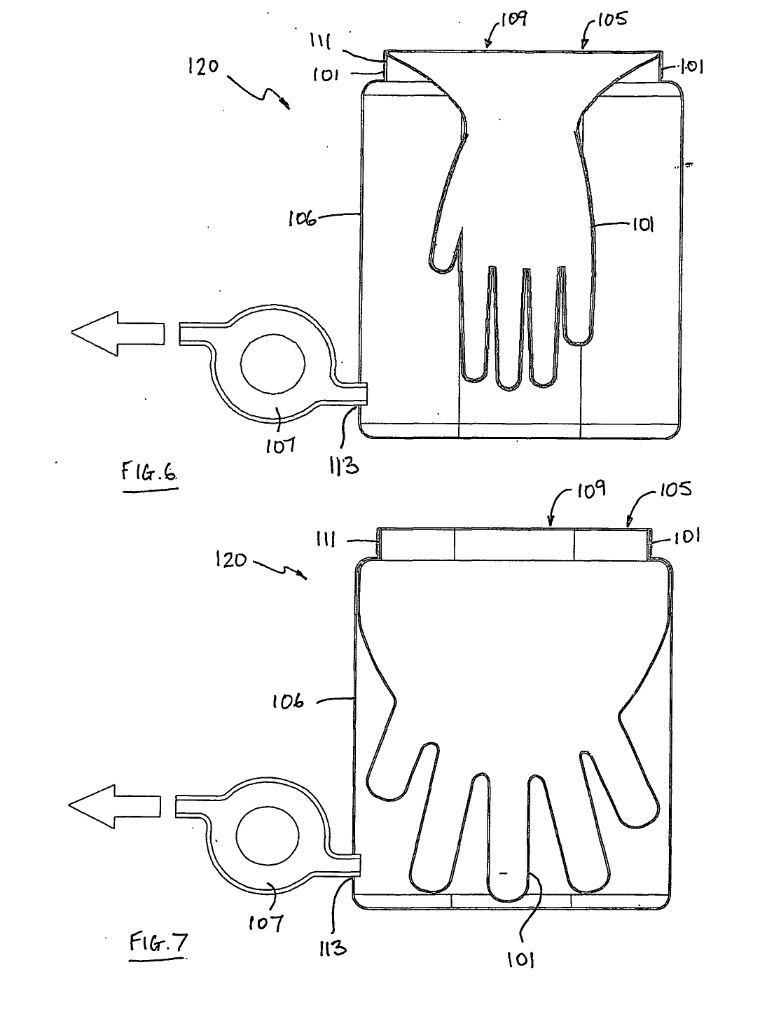

FIGS. 6 and 7 show an embodiment of a dispensing apparatus 120 that is generally similar to the apparatus 20 and to which similar descriptions apply. The apparatus 120 has a chamber 106 which as an open mouth 109 around which is provided a peripheral rim or collar 111. In the preferred embodiment, the collar 111 projects generally perpendicularly to the plane in which the mouth 109 lies. The chamber includes a second opening or port 113 by which a vacuum pump 107, or other gas extraction means, may evacuate air (or other gas) from the chamber 106 via a suitably sealed connection. As for other embodiments of the invention, the gas/air extraction means may take any suitable form, including manually operated pumps or bellows. The walls of the chamber 106 are advantageously rigid, or at least sufficiently rigid to resist deforming when air is evacuated from the chamber 106.

In use, a glove 101 is fitted over the mouth 109 of the chamber 106 by fitting the mouth end of the glove 101 over the collar 111 such that the end portion of the glove 101 embraces the outer surface of the collar 111. In the embodiment of FIGS. 6 and 7, it is assumed that the glove 101 is elastic and resilient and, having been stretched over the collar 111, is therefore self-retaining thereon by means of an elastic gripping action. As described for FIGS. 1 to 5, the glove 101 may comprise a peripheral ring or rolled portion at its mouth end, although this is not shown in FIGS. 6 and 7. Alternatively, retaining means, such as one or more clips or bands (not shown) may be provided at the mouth 109 of the chamber 106 for holding the glove, or other item, in place. When fitted, the glove 101 seals the mouth 109 of the chamber 106 and is positioned so that the opening or mouth 105 of the glove 101 is exposed to the external environment while the remainder of the glove 101 is located in the chamber 106.

When the pump 107 is activated, air is extracted from the chamber via port 113 thereby creating a pressure differential between the internal and external surfaces of the glove 101 as previously described. Accordingly, the glove 101 expands as shown in FIG. 7. To remove the glove 101 from the chamber 106, the user may (with one hand inserted into the glove 101) peel the end of the glove 101 off the collar 111. If no other gloves remain fitted to the chamber 106, this breaks the seal at the mouth 109 of the chamber 106 and allows air into the chamber 106. In any event, removing the glove from its seat at the mouth 109 equalises the pressure between the internal and external surfaces of the glove 101 and allows the glove 101 to contract around the user's hand. The user may then withdraw his gloved hand from the chamber 106. Alternatively, means for dislodging the end of the glove from the collar 113 may be provided on the external surface of the chamber 106, for example the latch mechanism 4 illustrated in FIG. 3. The port 113 may include a valve operable to allow air to be drawn into the chamber 106. This is useful after one glove has been dispensed but other gloves remain fitted to the chamber.

A valve (not shown) may be provided at port 113 for controlling the flow of gas into and out of the chamber 106 via port 113. The valve may comprise a one way valve configured only to let gas be drawn out of the chamber 106. Alternatively, the valve may be configured to allow gas to return into the chamber 106 when the pump 107 is inactive. Hence, the glove(s) 101 may or may not return to their unexpanded state when the pump 107 is turned off, depending on what type of valve is selected.

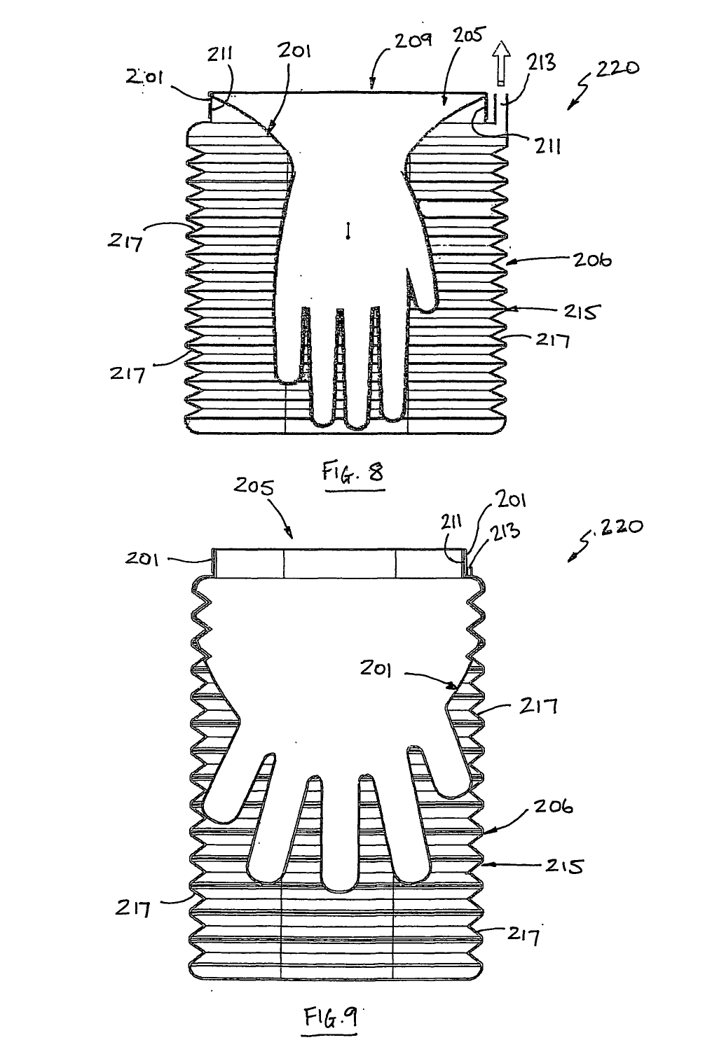

FIGS. 8 and 9 illustrate a further embodiment of a dispensing apparatus 220. The apparatus 220 comprises a chamber 206 having a mouth 209 and advantageously a collar 211. The mouth 209 and the collar 211 may be substantially the same as described for previous embodiments. The chamber 206 includes a port 213 at which a valve (not shown) is located. When the glove 201 is fitted to the chamber 206, the chamber 206 is sealed such that the valve controls the flow of air (or other fluid) into and out of the chamber 206 via the port 213. At least a portion of the body 215 of the chamber 206 is reversibly compressible, expandable or extendible such that the internal volume of the chamber 206 may be increased and decreased. The valve has at least one operational mode in which it permits air to be expelled from the chamber 206 via port 213 but prevents air from entering the chamber 206 via port 211. When the glove 201 is fitted to the chamber 206, the air pressure within the chamber 206 is approximately equal to the external or ambient pressure. When the body 215 is compressed, the internal volume of the chamber 206 is reduced and air is expelled from the chamber 206 via port 213. Subsequently, when the body 215 is expanded or extended, the internal volume of the chamber 206 is increased but air is not drawn into the chamber 206 via port 213. Accordingly, there is a decrease in the pressure of the air within the chamber 206. As a result, the air pressure inside the chamber 206 (which acts on the external surface of the glove 201) is less that the ambient pressure (which acts on the internal surface of the glove 201). This causes the glove 201 to expand as shown in FIG. 9. The expanded glove 201 may then be fitted to a user's hand and removed from the chamber 206 in the manner described above for previous embodiments, or in any other convenient manner.

In a preferred embodiment, at least part, and preferably substantially the entire, body 215 is fluted or fan-like so that it may be compressed and extended in a concertina-like manner. This may be achieved by shaping the walls of the chamber 206 to define a plurality of substantially parallel flutes 217 in the form of, for example, V-shaped grooves. Preferably, the flutes 217 extend around substantially the entire periphery of the chamber 206. As can be seen from FIGS. 8 and 9, the flutes 217 may run substantially parallel with the plane in which the mouth 209 lies, or substantially perpendicular with the longitudinal axis of the chamber 206. Conveniently, the walls of the chamber 206 may be formed from a flexible material such as plastics or polymer material in which flutes or ribs are formed to allow the chamber 206 to fold and unfold in a fan-like manner.

In alternative embodiments, the body 215 may be reversibly compressible by any other means, for example by providing the body with two or more telescopically arranged portions.

The body 215 has a rest state in which it adopts a particular state of compression/expansion. Typically, the glove 201 is fitted to the chamber 206 when the body 215 is in the rest state. Subsequently, the body 215 is squeezed so that the flutes 217 fold and the body 215 compresses (this may, for example, be effected manually by the user) causing air to be expelled via port 213. This compressed state is shown in FIG. 8. Then, the body 215 is stretched (conveniently by the user or of the body's own motion) to an extended state as shown in FIG. 9.

The valve is preferably operable in a second mode in which it allows air to be drawn into the chamber 206 via the port. This allows the pressure within the chamber 206 to equalise with the external pressure and typically causes the body 215 to revert to its rest state. This is particularly advantageous in cases where more than one glove at a time are fitted to the chamber 206 since, after one glove has been removed, the remaining gloves are allowed to adopt a rest or unexpanded state until the next glove is required to be dispensed.

It is preferred that substantially the entire body 215 is compressible since this allows the chamber 206 to be compressed to a relatively small size for storage and transport purposes.

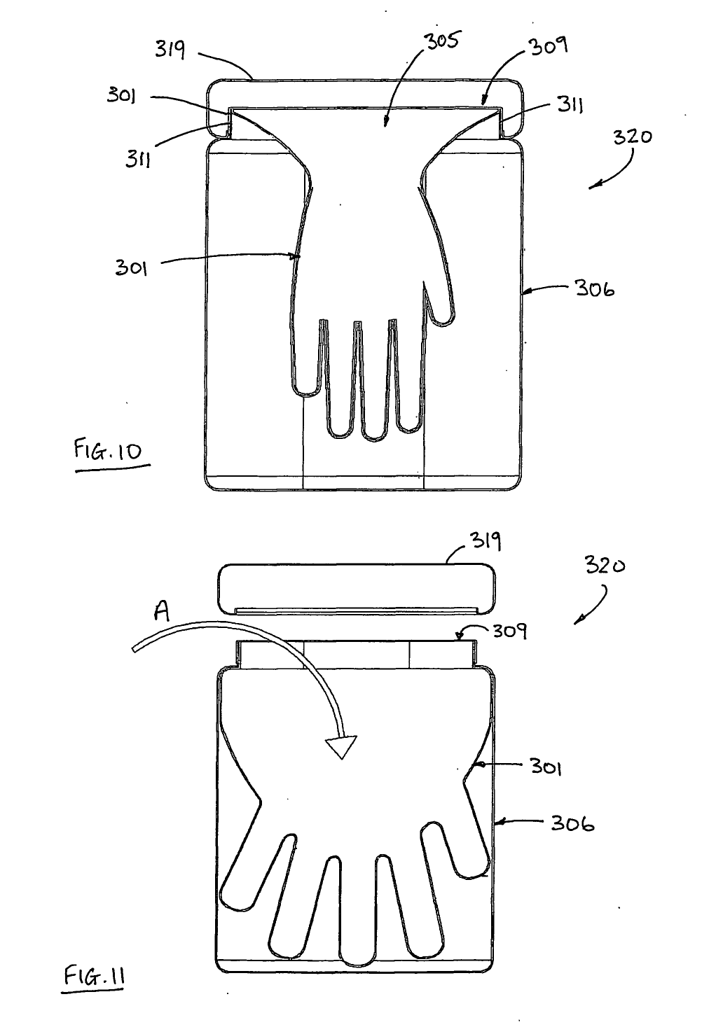

FIGS. 10 and 11 illustrate a still further embodiment of a dispensing apparatus 320. The apparatus 320 comprises a chamber 306 having a mouth 309 and, advantageously, a collar 311 around the mouth 309. The chamber 306 is advantageously formed from rigid or semi-rigid material. The collar 311 and mouth 309 may be the same as those described for the apparatus 120, 220 and one or more gloves 301 may be fitted to the chamber 306 in the same manner described above. Unlike previous embodiments, the dispenser 320 does not include means for evacuating air from the chamber 306 and so there is no requirement for the chamber to have a port or other opening for this purpose. The apparatus 320 includes a lid 319 for closing the mouth 309 in an air-tight, or substantially air-tight manner. In the illustrated embodiment, the lid 319 fits over the collar 311 and forms a seal with the outer surface if the collar 311. When fitted, the lid 319 covers the open mouth 305 of the glove 301 (or outermost glove when more than one glove is fitted) to create a sealed section or volume defined by the inner surface of the lid 319, the outer surface of the collar 319 and the inner surface of the glove 301 (or outermost glove). The lid 319 may be fitted to/removed from the apparatus 320 by any suitable conventional mechanism.

The apparatus 320 has a storage state (FIG. 10) in which one or more gloves 301 are fitted to the apparatus and in which the lid 319 is closed. The apparatus 320 thus comprises two sealed sections, the glove(s) defining the boundary between the sections. Each section is partially evacuated such the air (or other gas) pressure in each section is less than normal ambient or atmospheric pressure. A pressure equilibrium is obtained between sections, preferably such that the glove(s) 301 are maintained in a substantially unexpanded state. Conveniently, a partial vacuum can be created in each section at the time of manufacture of the apparatus 320.

When it is desired to dispense a glove, the user removes the lid 319 thereby allowing air at ambient pressure to fill the glove 301 (or the outermost glove 301) as indicated by arrow A. This causes the glove(s) to expand (as shown in FIG. 11) since the pressure inside the chamber 306 is lower than the ambient pressure. The user may then place his hand into the expanded glove, and then remove his gloved hand, as described above.

The invention is not limited to use with gloves. More generally, apparatus embodying the invention may comprise a body portion and a mouth, or opening, that allows access to the interior of the body portion, wherein the body portion is otherwise impermeable to fluids so that it may seal the mouth of the chamber. The body portion should be formed at least partially from flexible material, preferably resilient, elastic material, although the invention is suited to use with items formed from non-elastic material, e.g. PVC. In preferred embodiments, the dimensions of the chamber mouth are such that the mouth or peripheral ring of the item is smaller than the chamber mouth so that the mouth or peripheral ring of the item must be stretched to be located over the chamber mouth.

Preferred embodiments of the invention are particularly suited for use in cases where the item, especially gloves or other items to be worn, to be dispensed is required to be kept sterile after it has been donned by a user. Since the user can don the glove, or other item, without having to touch its external surface with his other hand, the risk of contaminating the glove or causing cross-contamination of a patient is greatly reduced. In applications where sterility is important, the inside of the chamber may be kept sterile, or the outermost glove may be discarded. It is preferred, however, to provide an outer lining (not shown) around the outermost glove (or other item) in order to maintain sterility. The outer lining may be peeled off before use. Alternatively, each item may be provided with an outer lining that may be peeled off before use.

The invention is not limited to the embodiments described herein which may be modified or varied without departing from the scope of the invention.

1. An apparatus for dispensing an item having a body portion and an opening allowing access to the interior of the body portion, the apparatus comprising a chamber having a mouth, the mouth being shaped and dimensioned to receive the opening of the item, the opening of at least one item being fitted to the mouth, in use, so as to provide a substantially fluid-tight seal at the mouth and such that at least part of the, or each, body portion is located inside the chamber; the apparatus further comprising means for causing a pressure differential between the interior surface and exterior surface of said at least one item.

2. An apparatus as claimed in claim 1, wherein said chamber comprises an opening, said pressure differential causing means comprises means for evacuating gas from said chamber through said chamber opening.

3. An apparatus as claimed in claim 2, wherein said evacuating means comprises a gas extraction means such as a pump or fan.

4. An apparatus as claimed in claim 2, wherein said evacuating means comprised means for expelling gas from the chamber.

5. An apparatus as claimed in claim 4, wherein said chamber opening is fitted with a valve, the valve being operable in at least a first mode in which it permits gas to be expelled from the chamber through the chamber opening and substantially prevents gas from being drawn into the chamber through the chamber opening.

6. An apparatus as claimed in claim 5, wherein the valve is operable in a second mode in which gas is permitted to enter the chamber through said chamber opening.

7. An apparatus as claimed in claim 4, wherein as least a portion of the chamber is reversibly compressible, the volume defined by the chamber depending on the state of compression of said at least a portion of the chamber.

8. An apparatus as claimed in claim 7, wherein said at least a portion of the chamber comprises at least one fluted portion that is foldable in a concertina-like manner.

9. An apparatus as claimed in claim 8, wherein the chamber comprises a body having a plurality of substantially parallel flutes, the body being foldable in a concertina-like manner.

10. An apparatus as claimed in claim 1, wherein the apparatus further includes a removable lid for the mouth of the chamber, the lid, when fitted over the mouth, forming a substantially fluid tight seal around the mouth and said at least one item to create a first and second sealed section in the apparatus, said first and second sections being partitioned by said at least one item, and wherein each of said first and second sections are maintained, before the lid is removed, in a state of partial vacuum.

11. An apparatus as claimed in claim 1, wherein a collar is provided around the chamber mouth, the collar being arranged to receive the opening of said at least one item.

12. An apparatus as claimed in claim 11, wherein the collar projects from the mouth in a direction generally perpendicular with the plane in which the mouth lies.

13. A dispensing system comprising an apparatus as claimed in claim 1, the system further including said at least one item fitted to the chamber mouth.

14. A dispensing system as claimed in claim 13, wherein said at least one item comprises at least one glove, preferably formed at least partially from flexible material, and more preferably from resilient elastic material.

15. A method of dispensing an item having a body portion and an opening allowing access to the interior of the body portion, the method comprising fitting the opening of at least one item to the mouth of a chamber so as to provide a substantially fluid-tight seal at the mouth and such that at least part of the, or each, body portion is located inside the chamber; and causing a pressure differential between the interior surface and exterior surface of said at least one item.

16. A method as claimed in claim 15, wherein said chamber comprises an opening, the method further including evacuating gas from said chamber through said chamber opening.

17. A method as claimed in claim 16, wherein said chamber comprises an opening and at least a portion of the chamber is reversibly compressible, the method comprising expelling air from said chamber by compressing said at least a portion of the chamber; and uncompressing said at least a portion of the chamber.
